(19) United States
(12) Patent Application Publication
(10) Pub. No.: US 2006/0255716 A1
(43) Pub. Date: Nov. 16, 2006

(54) Light emitting apparatus and vehicle lamp

(75) Inventors: Yasuaki Tsutsumi, Shizuoka (JP); Hisayoshi Daicho, Shizuoka (JP)

Correspondence Address: OSHA LIANG L.L.P., 1221 MCKINNEY STREET, SUITE 2800, HOUSTON, TX, 77010, US

(73) Assignee: KOITO MANUFACTURING CO., LTD., Tokyo (JP)

(21) Appl. No.: 11/432,441

(22) Filed: May 11, 2006

(30) Foreign Application Priority Data
May 16, 2005 (JP) 2005-142398

(51) Int. Cl. H01J 1/62; H01J 63/04

(52) U.S. Cl. 313/502

(57) ABSTRACT

A light emitting apparatus includes a device protective layer including a transparent binder (A) and particles (B), and a light emitting device coated with the device protective layer, characterized in that the transparent binder (A) contains one or more ceramics, and the particles (B) have a smaller particle diameter than the wavelength of the light produced by the light emitting device, and characterized in that the refractive index of the device protective layer is preferably 1.4 or more, the particle diameter of the particles (B) is 100 nm or less, and the device protective layer contains a phosphor therein. The light emitting apparatus can form a vehicle lamp high in luminous efficiency.

This application claims foreign priority based on Japanese Patent application No. 2005-142398, filed May 16, 2005, the contents of which is incorporated herein by reference in its entirety.

### BACKGROUND OF THE INVENTION

1. Field of the Invention

The present invention relates to a light emitting apparatus and a vehicle lamp.

2. Description of the Related Art

In recent years, from the viewpoints of energy conservation of a light emitting apparatus, and the reduction of environmental load (mercury-free), light emitting apparatuses producing white light using a semiconductor light emitting device and a phosphor have received attention such as disclosed in JP-A-2002-134795 or JP-A-2002-185048.

Such a light emitting device has been improved in luminous efficiency and has become brighter. Therefore, when the transparent binder of the device protective layer is an organic substance such as a resin, light degradation occurs. The following case may occur: the resin is colored by degradation, and absorbs light, so that the light produced by the light emitting device cannot be sufficiently extracted.

The following system has also been proposed. In order to produce white light, a light emitting device is allowed to emit light in the near-ultraviolet region, which is converted to white light by a phosphor. This type of system improves the color rendering property, i.e., the manner in which an object is seen when it is illuminated, and hence it is preferable as an illumination apparatus such as disclosed in non-patent publication, “O plus E”, Mar., 2004, at page 271.

### SUMMARY OF THE INVENTION

In such a light emitting apparatus as described above, the following problem has become noticeable: ultraviolet light intensifies the light degradation of the resin for use in the transparent binder as compared with visible light.

On the other hand, when the refractive index of the device protective layer in the light emitting apparatus is low, and the light produced by the semiconductor light emitting device is made incident upon the device protective layer, the light produced by the semiconductor light emitting device may undergo total reflection at the interface between the semiconductor light emitting device and the device protective layer. As a result, there are some cases where a part of the light produced by the semiconductor light emitting device is not applied to the phosphor in the device protective layer. For this reason, there are some cases where the light produced by the semiconductor light emitting device cannot be applied efficiently outside the light emitting apparatus.

Therefore, in one or more embodiments of the invention provide a light emitting apparatus configured such that the light deterioration of the device protective layer has been suppressed and the refractive index of the device protective layer has been raised, and thereby the light produced by the light emitting device is extracted efficiently, and a vehicle lamp high in luminous efficiency using the same.

The present inventors conducted a close study, and as a result, they found out the following fact. To a transparent binder, a ceramic derived from a metal alkoxide or polysilazane, and particles with a particle diameter of 100 nm or less are added to make the refractive index of the device protective layer 1.4 or more. As a result, the foregoing problem can be solved, and an objective light emitting apparatus and vehicle lamp can be obtained.

Namely, the constitution of one or more embodiments of the invention is as follows.

(1) A light emitting apparatus which includes a device protective layer including a transparent binder (A) and particles (B), and a light emitting device coated with the device protective layer, characterized in that the transparent binder (A) contains one or more ceramics, and the particles (B) have a smaller particle diameter than the wavelength of light produced by the light emitting device.

(2) The light emitting apparatus according to the item (1), characterized in that the transparent binder (A) is a ceramic derived from one or more metal alkoxides or polysilazane.

(3) The light emitting apparatus according to the item (1) or (2), characterized in that the refractive index of the device protective layer is 1.4 or more.

(4) The light emitting apparatus according to any of the items (1) to (3), characterized in that the particle diameter of the particles (B) is 100 nm or less.

(5) The light emitting apparatus according to any of the items (1) to (4), characterized in that the device protective layer includes a phosphor therein.

(6) The light emitting apparatus according to any of the items (1) to (5), characterized in that the light emitting device emits 420- or less nm near-ultraviolet light or short wavelength visible light.

(7) The light emitting apparatus according to any of the items (1) to (6), characterized in that the light emitting device is mounted on a substrate by a flip-flop process.

(8) A vehicle lamp characterized by including the light emitting apparatus according to any of the items (1) to (7).

A light emitting apparatus in accordance with one or more embodiments of the present invention is configured such that the light degradation of the device protective layer has been suppressed, and the refractive index of the device protective layer has been raised, and thereby the light produced by the light emitting device can be extracted efficiently. By using the light emitting apparatus, it is possible to provide a vehicle lamp with a high luminous efficiency.

### BRIEF DESCRIPTION OF THE DRAWINGS

FIG. 1 is a perspective view of a vehicle lamp 10;

FIG. 2 is a horizontal cross-sectional view of the vehicle lamp 10;

FIG. 3 is a cross-sectional view along CC of a LED module 100;

FIG. 4 is a top view of the LED module 100;

FIG. 5 is a view showing one example of a detailed construction of a light emitting device 102 and a device protective layer 106;

FIG. 6 is a view further specifically illustrating a sealing member 108;

FIG. 7 is a view showing another example of a construction of the device protective layer 106 and the sealing member 108; and

FIG. 8 is a view showing a still other example of a construction of the device protective layer 106.

### DESCRIPTION OF THE PREFERRED EMBODIMENTS

Embodiments of the present invention will be described hereinbelow by reference to the drawings. Unless otherwise specifically defined in the specification, terms have their ordinary meaning as would be understood by those of ordinary skill in the art.

Below, the present invention will be described by way of the embodiments of the invention. It should be noted, however, that the following embodiments do not limit the scope of the invention defined by the claims, and all the combinations of features described in the embodiments are not necessarily essential for the solving means of the invention.

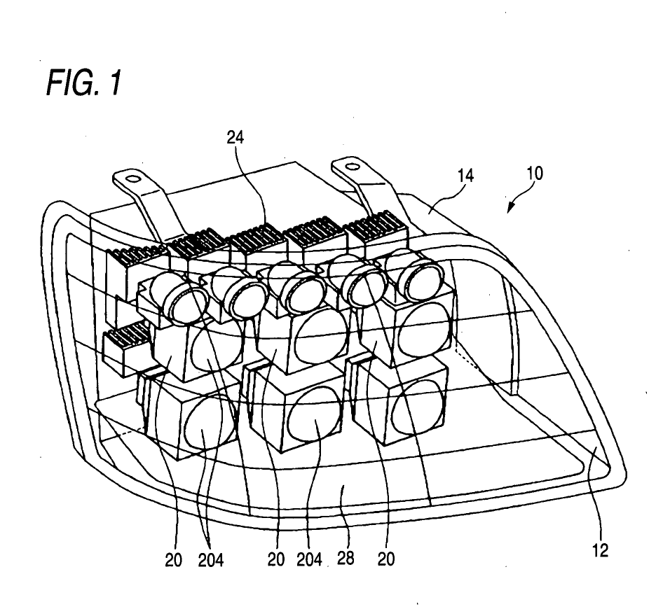

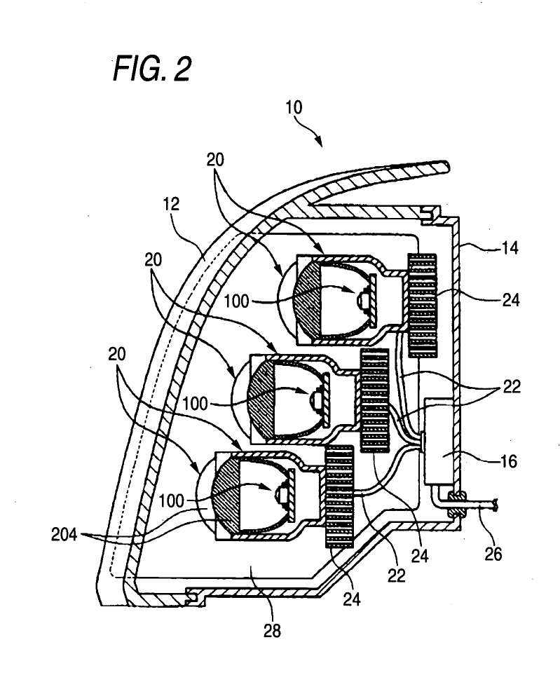

First, the outline will be described. FIGS. 1 and 2 each show one example of the constitution of a vehicle lamp 10 in accordance with one embodiment of the invention. FIG. 1 is a perspective view of the vehicle lamp 10. FIG. 2 is a horizontal cross-sectional view through the horizontal plane crossing light source units 20 in the intermediate stage of the vehicle lamp 10. This embodiment provides a vehicle lamp 10 high in luminous efficiency by efficiently extracting the light produced by the semiconductor light emitting device of the vehicle lamp 10. The vehicle lamp 10 is, for example, a headlamp for use in an automobile or the like, and applies light to the front of the vehicle. The vehicle lamp 10 includes a plurality of light source units 20, a cover 12, a lamp body 14, a circuit unit 16, a plurality of radiative members 24, an extension reflector 28, and cables 22 and 26.

A plurality of the light source units 20 each have an LED module 100 and a lens 204. The LED module 100 is one example of the light emitting apparatus in accordance with embodiments of the invention, and produces white light according to the electric power received from the circuit unit 16 through the cable 22. The lens 204 is one example of the optical member in accordance with embodiments of the invention, applies the light produced by the LED module 100 outside the vehicle lamp 10. As a result, the light source units 20 apply the light forming a part of the light distribution pattern of the vehicle to the front of the vehicle based on the light produced by the LED module 100. The light source units 20 are, for example, supported on the lamp body 14 tiltably by an aiming mechanism for controlling the direction of the optical axes of the light source units 20. The light source units 20 may be supported on the lamp body 14 so that the direction of the optical axis when the vehicle lamp 10 is mounted in the vehicle body is oriented downwardly, for example, by about 0.3 to 0.6 degree.

Incidentally, a plurality of the light source units 20 may have the same or similar light distribution characteristics, or may respectively have different light distribution characteristics. Whereas, in another example, one light source unit 20 may have a plurality of LED modules 100. The light source unit 20 may have, for example, a semiconductor laser in place of the LED module 100 as the light emitting apparatus.

The cover 12 and the lamp body 14 form a lighting chamber of the vehicle lamp 10, and accommodates a plurality of the light source units 20 in the lighting chamber. The cover 12 and the lamp body 14 preferably make the light source units 20 airtight and waterproof. The cover 12 is formed in the transparent condition with a material which transmits the light produced by the LED module 100 therethrough, and disposed at the front side of the vehicle so as to cover the front of a plurality of the light source units. The lamp body 14 is disposed so as to oppose the cover 12 across a plurality of the light source units 20 interposed therebetween, and to cover a plurality of the light source units 20 from the rear direction. The lamp body 14 may be formed integrally with the body of the vehicle.

The device protective layer 106 developed in accordance with embodiments of the invention may also be coated on the surfaces of the cover 12, the light source units 20, the LED modules 100, and the lenses 204 to be used as a functional film of an optical filter or the like.

The circuit unit 16 is a module in which a lighting circuit for lighting the LED module 100 and the like are formed. The circuit unit 16 is electrically connected to the light source units 20 via the cables 22. The circuit unit 16 is electrically connected to the outside of the vehicle lamp 10 via the cables 26.

A plurality of the radiative members 24 are heat sinks each disposed in contact with at least a part of each light source unit 20. The radiative members 24 are formed by a material having a higher thermal conductivity than that of air, such as a metal. The radiative members 24 are disposed movably with the light source units 20, for example, in the region in which the light source units 20 are moved with respect to the supporting point of the aiming mechanism, and with a space enough for conducting the optical axis alignment of the light source units 20 from the lamp body 14. A plurality of the radiative members 24 may be formed in one piece of one metal member. In this case, heat can be efficiently radiated from the whole of a plurality of the radiative members 24.

The extension reflector 28 is a reflection mirror formed of, for example, a thin metal plate, from underneath a plurality of the light source units 20 over the cover 12. The extension reflector 28 is formed so as to cover at least a part of the inner surface of the lamp body 14. As a result, it hides the shape of the inner surface of the lamp body 14, and improves the appearance of the vehicle lamp 10.

At least a part of the extension reflector 28 comes in contact with the light source units 20 and/or the radiative members 24. In this case, the extension reflector 28 has a function of a heat conductive member of conducting the heat generated by the LED module 100 to the cover 12. As a result, the extension reflector 28 causes the LED module 100 to radiate heat. A part of the extension reflector 28 is fixed on the cover 12 or the lamp body 14. The extension reflector 28 may be formed in the shape of a case covering the top, bottom, and lateral sides of a plurality of the light source units 20.

In accordance with this example, use of the LED module 100 as a light source can reduce the size of the light source unit 20. Further, for example, this improves the degree of freedom of arrangement of the light source units 20. Therefore, it is possible to provide the vehicle lamp 10 with high designability.

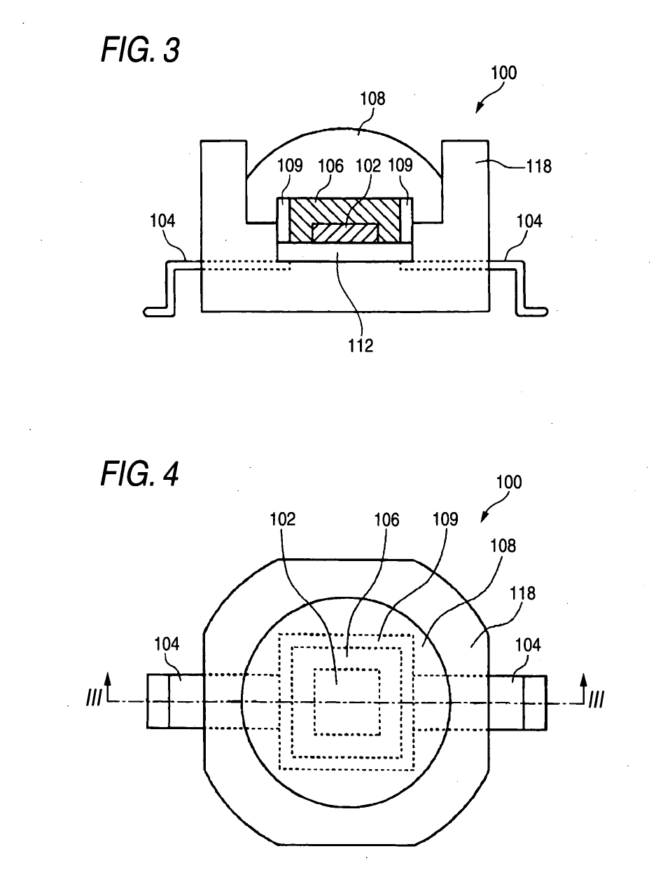

FIGS. 3 and 4 show one example of the construction of the LED module 100. FIG. 3 is a cross-sectional view along CC of the LED module 100, and FIG. 4 is a top view of the LED module 100. The LED module 100 has a substrate 112, a plurality of electrodes 104, a cavity 109, a holding member 118, a sealing member 108, a light emitting device 102, and a device protective layer 106.

The substrate 112 is a plate-like body, and mounts and fixes the light emitting device 102 on the top surface. The substrate 112 includes wiring for electrically connecting the electrodes 104 and the light emitting device 102, and supplies the electric power received from a plurality of the electrodes 104 to the light emitting device 102. A plurality of the electrodes 104 supply the electric power received from the outside of the LED module 100 to the light emitting device 102 via the substrate 112. The cavity 109 is a hollow space formed so as to surround the light emitting device 102 on the substrate 112, and holds the device protective layer 106 in the inside.

The holding member 118 holds a plurality of the electrodes 104, the substrate 112, the cavity 109, and the sealing member 108. At least a part of the holding member 118 is formed of a material having a higher thermal conductivity than that of air, such as a metal, and conducts the heat generated by the light emitting device 102 outside the LED module 100.

The light emitting device 102 is one example of the semiconductor light emitting device in accordance with embodiments of the invention, and produces ultraviolet light according to the electric power received from the outside of the LED module 100 via the electrodes 104 and the substrate 112. In another example, the light emitting device 102 may produce, for example, blue light in place of ultraviolet light.

The device protective layer 106 is filled in the cavity 109, and thereby disposed in such a manner as to cover the surface of the light emitting device 102. It produces light in the visible region such as white light, red light, green light, yellow light, orange light, and blue light according to the ultraviolet light produced by the light emitting device 102. Incidentally, when the light emitting device 102 produces blue light, the device protective layer 106 may produce yellow light which is the complementary color of blue color according to the blue light produced by the light emitting device 102. In this case, the LED module 100 produces white light based on the blue light and yellow light produced by the light emitting device 102 and the device protective layer 106, respectively.

The sealing member 108 seals the light emitting device 102 and the device protective layer 106. The sealing member 108 is formed of a material transmitting visible light therethrough so as to oppose the light emitting device 102 across the device protective layer 106 interposed therebetween. As a result, the sealing member 108 transmits the light produced by the device protective layer 106, and emits the light outside the LED module 100. In accordance with this example, the LED module 100 can properly apply the resulting light outwardly.

Incidentally, in another example, the LED module 100 may have a plurality of the light emitting devices 102. In this case, the device protective layer 106 is disposed, for example, in common to a plurality of the light emitting devices 102 and in such a manner as to cover these. The sealing member 108 seals a plurality of the light emitting devices 102 and the device protective layer 106.

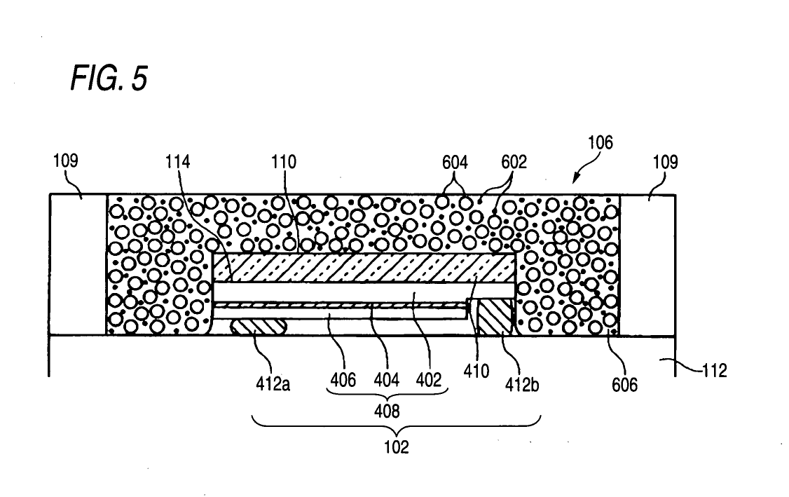

FIG. 5 shows one example of a detailed construction of the light emitting device 102 and the device protective layer 106 together with the substrate 112 and the cavity 109. Incidentally, a ratio different from the actual ratio is used as a ratio of sizes of respective portions for the sake of convenience of description. In this example, the light emitting device 102 has a semiconductor layer 408, a sapphire substrate 410, and a plurality of electrodes 412a and 412b, and is, for example, flip-chip mounted on the substrate 112 in such a manner that the sapphire substrate 410 opposes the substrate 112 across the semiconductor layer 408 interposed therebetween. The electrodes 412a and 412b are, for example, solder bumps, and electrically connect the semiconductor layer 408 and the substrate 112.

The sapphire substrate 410 transmits the light produced by the semiconductor layer 408 toward the sealing member 108. Then, the sapphire substrate 410 applies the transmitted light from the opposite side 110 opposing the sealing member 108 to the device protective layer 106. The opposite side 110 is, for example, a plane in the form of an about 1 square millimeter rectangle.

The semiconductor layer 408 is formed by crystal growth on the back side 114 of the opposite side 110 in the sapphire substrate 410, and produces light toward the sapphire substrate 410. In this example, the semiconductor layer 408 has an N type GaN layer 402, an InGaN layer 404, and a P type GaN layer 406. The N type GaN layer 402, the InGaN layer 404, and the P type GaN layer 406 are successively stacked and formed on the back side 114 of the sapphire substrate 410. The semiconductor layer 408 may further have another layer between these layers.

In this example, the semiconductor layer 408 produces, for example, ultraviolet light or short wavelength visible light with a wavelength of about 360 to 420 nm toward the sapphire substrate 410 according to the electric power received through the electrodes 412a and 412b, and the substrate 112. As a result, the light emitting device 102 produces ultraviolet light toward the device protective layer 106 with the opposite side 110 of the sapphire substrate 410 as the light emitting side. In another example, the semiconductor layer 408 may produce blue light toward the sapphire substrate 410.

The device protective layer 106 has particles 602, a phosphor 604, and a transparent binder 606. In this example, the device protective layer 106 has one or a plurality of phosphors 604 each producing different color light. The transparent binder 606 is formed of, for example, ceramics, a silicone resin, or a fluororesin, or an epoxy resin in such a manner as to cover the opposite side 110 with is the light emitting side of the light emitting device 102, and essentially includes at least one or more ceramics. The binder 606 includes the particles 602 and the phosphor 604 in the inside. As a result, the transparent binder 606 is formed in a layer covering the light emitting side of the light emitting device 102, and holds the particles 602 and the phosphor 604. Incidentally, the particles 602 and the phosphor 604 in the transparent binder 606 may be dispersed in a uniform density. The device protective layer 106 may have a single phosphor 604. For example, when the light emitting device 102 produces blue light, the device protective layer 106 may have the phosphor 604 producing yellow light according to blue light.

The phosphor 604 has a particle diameter of, for example, about 50 μm, and produces light in the visible region according to ultraviolet light produced by the light emitting device 102. Respective kinds of phosphors 604 produce, for example, white light, red light, green light, yellow light, orange light, or blue light according to ultraviolet light from the light emitting device 102.

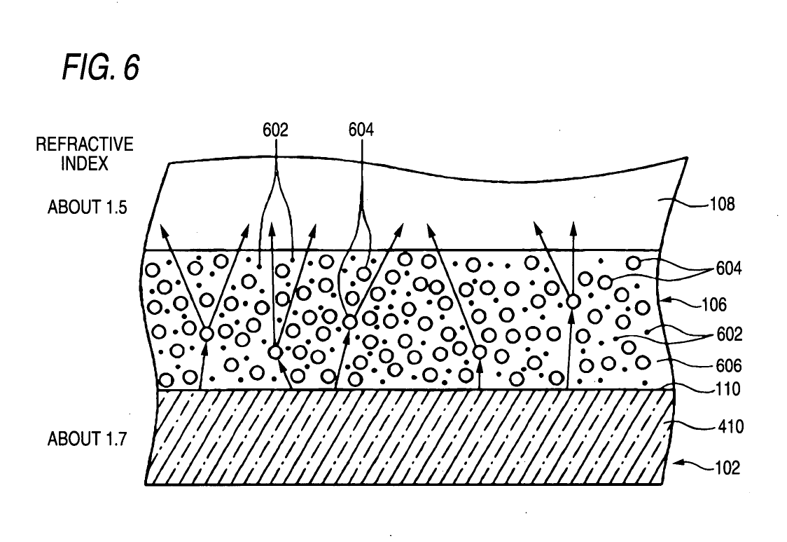

FIG. 6 is a diagram illustrating the sealing member 108 in more detail. The sealing member 108 is formed in such a manner as to cover the device protective layer 106 and the light emitting device 102, and thereby seals the device protective layer 106 and the light emitting device 102. In this example, the sealing member 108 is disposed in opposite to the sapphire substrate 410 across the device protective layer 106 interposed therebetween. In this example, the sapphire substrate 410 has a refractive index of about 1.7. In this example, the sealing member 108 is formed of, for example, glass, a silicone resin, or an epoxy resin, and has a refractive index of about 1.4 to 1.5. The silicone resin may be, for example, dimethyl silicone or phenylsilicone resin. The epoxy resin may be, for example, bisphenol A type epoxy (transparent epoxy), biphenyl epoxy, or alicyclic epoxy.

Below, the light emitting apparatus and the vehicle lamp of the invention will be described in detail.

Embodiments of the invention provide a light emitting apparatus which includes a device protective layer made of a transparent binder 606 (A), and particles 602 (B), and a light emitting device coated with the device protective layer, characterized in that the transparent binder 606 (A) includes one or more ceramics, and the particles 602 (B) have a smaller particle size than the wavelength of the light produced by the light emitting device and a vehicle lamp.

For the transparent binders 606 (A) in the invention, mention may be made of inorganic materials such as ceramics and inorganic/organic hybrid materials transparent to visible light and/or ultraviolet light. As the organic components, mention may be made of organic compounds such as epoxy resin, silicone resin, cycloolefin resin, fluororesin, acrylic resin, polycarbonate resin, polyester resin, urethane resin, polyamide resin, polyimide resin, polysulfone resin, polystyrene, polyethylene, and polypropylene.

Herein, the light emitting device 102 of the vehicle lamp 10 may emit light with an efficiency of, for example, 50 lm/W or more. In this case, the illuminance of ultraviolet light produced by the light emitting device 102 may be, for example, 10000 to 20000 times that of sunlight. For this reason, when the light resistance of the material of the transparent binder 606 to ultraviolet light is low, the transparent binder 606 may undergo, for example, yellowing or cracks. In this case, reduction of luminous flux, changes in color of emission light, and the like may occur. In order to avoid this, a close study has been made. As a result, it has been found that, as the materials high in light resistance to ultraviolet light, ceramics using a metal alkoxide or polysilazane as a raw material are preferable.

As ceramics, any kinds of non-metal inorganic materials are acceptable. Out of these, examples of the transparent ones may include alumina (Al₂O₃), magnesia (MgO), beryllia (BeO), scandiumoxide (Sc₂O₃), gadolinium oxide (Gd₂O₃), spinel (MgAl₂O₄), calcia(CaO), hafnia (HfO₂), zirconia (ZrO₂), thoria (ThO₂), dysprosium oxide (Dy₂O₃), holmium oxide (Ho₂O₃), erbium oxide (Er₂O₃), thulium oxide (Tm₂O₃), yttrium oxide (Y₂O₃), LiAl₅O₈, zinc oxide (ZnO), SiO₂, PZT (solid solution of lead zirconate (PbZrO₃) and lead titanate (PbTiO₃), PLZT (Pb₁₋ₓ, Laₓ) (Zr_{y}, Ti_{1-y})_{1-x/4}O₃, (Pb, Bi) (Zr, Ti)O₃, (Pb, Sr) (Zr, Ti)O₃, (Pb, Ba) (Zr, Ti)O₃, (Pb, Sm) (Zr, Ti)O₃, (Sr, Nb) (Zr, Ti)O₃, (La, Nb) (Zr, Ti)O₃, (Pb, La) (Hf, Ti) O₃, (Pb, La) (Mg, Nb, Zr, Ti)O₃, (Pb, Ba) (La, Nb)O₃, (Sr, Ca) (Li, Nb, Ti) O₃, (Sr, Ba)Nb₂O₆, (Pb, Ba, La)Nb₂O₆, K(Ta, Nb)O₃, NaNbO₃-BaTiO₃, β-SIALON ((Si, Al)₆(O, N)₈), and Nb₂O₅.

For these ceramics, with any manufacturing method, for example, a powder is formed, and applied with temperature, pressure, and time for sintering. The sintered powder is formed in a film with sputtering or chemical vapor deposition (CVD) in vacuum.

Alternatively, mention may be made of a sol-gel process using a metal alkoxide as a raw material, a method of manufacturing from polysilazane, and the like.

With these methods using a metal alkoxide or polysilazane as a raw material, reaction and curing can be effected at 300° C. or less when coating is applied on the light emitting device. Therefore, coating can be applied without making the light emitting device inoperable. Thus, these methods are preferable.

Herein, there are various raw materials usable in the sol-gel process, which are represented by the following general formula (1):
R¹ₙM (OR²)ₘ (1)
(where in the formula, R¹ and R² each represent hydrogen or an organic group, and they may be the same or different substituents; M represents each element shown below; n represents 0 or an integer; and m represents a natural number.)

To a metal alkoxide in a solvent, water and a catalyst are added, thereby to effect a sol-gel reaction, resulting in the formation of ceramics.

As the elements usable for M in the general formula (1), mention may be made of Li, Na, K, Rb, Cs, Be, Mg, Ca, Sr, Ba, Sc, Y, Ti, Zr, Hf, V, Nb, Ta, Cr, Mo, W, Mn, Fe, Co, Ni, Cu, Zn, Cd, Hg, B, Al, Ga, In, Tl, C, Si, Ge, Sn, Pb, P, As, Sb, Bi, S, Se, Te, La, Ce, Pr, Nd, Pm, Sm, Eu, Gd, Tb, Dy, Ho, Er, Tm, Yb, and Lu.

Examples of metal alkoxides thereof may include Al(OC₃H₇)₃, Ba(OC₃H₇)₂, La(OC₃H₇)₃, Pb(OC₅H₁₁)₂, Si(OC₂H₅)₄, B(OCH₃)₃, Sn(OC₃H₇)₄, Sr(OC₃H₇)₂, Ti(OC₃H₇)₄, Ti(C₅H₁₁)₄, Zr(OC₃H₇)₄, and Zr(OC₅H₁₁)₄.

Polysilazane is an inorganic compound represented by (SiH₂NH)ₙ, and reacts with the water content in air to form SiO₂. It is synthesized by introducing ammonia into a complex of dichlorosilane and pyridine. Polysilazane is diluted with an appropriate solvent such as xylene, resulting in metaloxane sol in liquid form. The metaloxane sol can be heated and cured at around 170° C. to form strong metaloxane gel. Further, it is excellent in weather resistance, and does not undergo yellowing/coloring even under a high temperature environment and under short wavelength light irradiation.

It is possible to add a resin or an additive to the ceramics, if required.

In the device protective layer 106 including the transparent binder 606 (A) and the particles 602 (B), the particles 602 (B) essentially have a smaller particle diameter than the wavelength of the light produced by the light emitting device. When the particle diameter is smaller than the wavelength of light produced by the light emitting device 102, the particles 602 do not cut off the light produced by the light emitting device 102, and transmit the light to each phosphor 604. The light produced by the light emitting device 102 is applied to the phosphor 604 with efficiency, and converted in wavelength. Thus, it is possible to apply a visible light outside the LED module 100.

In order to efficiently extract a visible light outside, the particle diameter of the particles 602 is preferably 100 nm or less, and further preferably 80 nm or less.

Such particles 602 are preferably formed with inorganic compounds. Out of these, oxides, fluorine compounds, sulfides, and the like are particularly preferred. More specific preferred examples thereof may include a metal oxide such as aluminum oxide, antimony trioxide, beryllium oxide, hafnium dioxide, lanthanum oxide, magnesium oxide, scandium oxide, silicone dioxide, silicone trioxide, tantalum pentoxide, titaniumdioxide, thoriumoxide, yttriumoxide, or zirconium dioxide, or niobium oxide, a fluorine compound such as bismuth trifluoride, cerium fluoride, lanthanum fluoride, lead fluoride, neodymium fluoride, calcium fluoride, chiolite, cryolite, lithium fluoride, magnesium fluoride, or sodium fluoride, lead chloride, or lead telluride.

Incidentally, the particles 602 may be manufactured by, for example, a breakdown method in which particles are manufactured by grinding coarse particles by means of a ball mill, a bead mill, or the like, or a buildup method in which particles are manufactured from a raw material by a chemical reaction or a physical reaction, such as a plasma vapor process, a sol-gel process, or a CVD (chemical vapor deposition) process.

For example, when the device protective layer 106 and the sealing member 108 are formed with a silicone resin excellent in light resistance out of organic resins, the refractive index becomes about 1.4.

In the case of a lower refractive index than this, the refractive index of the light emitting device 102 is about 1.7, and hence when the produced light is made incident upon the device protective layer 106, reflection at the interface increases, resulting in a lower light extraction efficiency.

When the refractive index of the device protective layer 106 is 1.4 or more, it is possible to make the light produced by the light emitting device 102 incident upon the device protective layer 106 with efficiency, and it is possible to make the light produced by the phosphor 604 in the device protective layer 106 incident upon the sealing member 108 with efficiency.

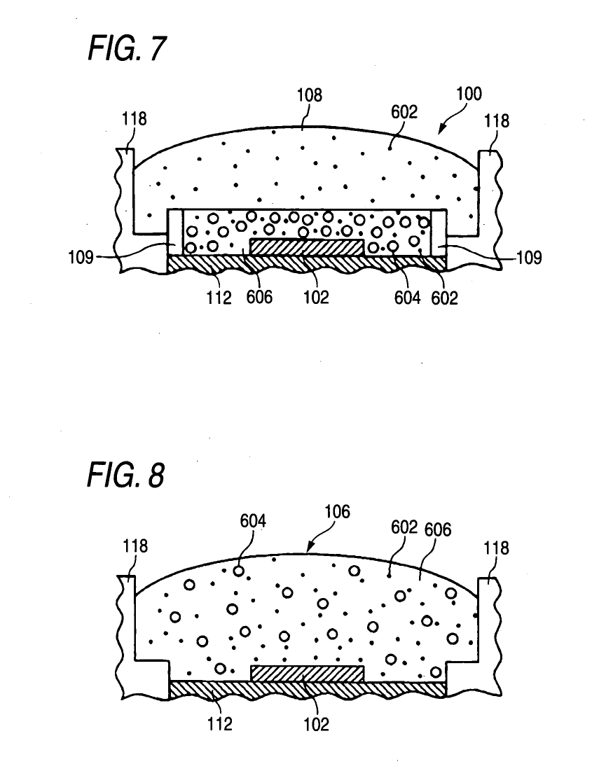

FIG. 7 shows another example of the construction of the device protective layer 106 and the sealing member 108 together with the substrate 112 and the cavity 109. Incidentally, in FIG. 7, the elements given the same reference numerals as those in FIG. 5 have the same or similar functions as those in FIG. 5, and hence, the description thereon is omitted. In this example, the sealing member 108 holds the particles 602 (B). As a result, the refractive index of the sealing member 108 becomes higher than the refractive index of the material of the sealing member 108. For this reason, it is possible to make the light produced by the device protective layer 106 incident upon the sealing member 108 with efficiency.

FIG. 8 shows another example of the construction of the device protective layer 106 together with the substrate 112 and the cavity 109. Incidentally, in FIG. 8, the elements given the same reference numerals as those in FIG. 5 have the same or similar functions as those in FIG. 5, and hence, the description thereon is omitted. The device protective layer 106 is formed in such a manner as to cover the light emitting device 102, and thereby seals the light emitting device 102. As a result, in this example, the device protective layer 106 also has a function of the sealing member 108 described in connection with FIG. 5. In the device protective layer 106, the particles 602 (B) are added to the binder 606 (A). Therefore, also in this example, the refractive index of the device protective layer 106 can be made closer to the refractive index of the sapphire substrate 410 of the light emitting device 102. For this reason, it is possible to make the light produced by the light emitting device incident upon the device protective layer 106 with efficiency, and it is possible to apply the light produced by the phosphor 604 in the device protective layer 106 outside the LED module 100 with efficiency.

Up to this point, the invention was described by way of the above embodiments. However, the technical scope of the invention is not limited to the scope described in the embodiments. It is obvious to those skilled in the art that various changes or improvements can be made to the disclosed embodiments without departing from the spirit of the invention. It is obvious from the description of the claims that the technical scope of the invention covers embodiments subjected to such changes or improvements.

### EXAMPLES

Below, the invention will be described by way of specific examples. However, the invention is not limited to these examples.

Before going into description of the examples, the evaluation method of the examples will be described.

In each example and comparative example, on a quartz glass with a thickness of 1 mm, a film was formed with a thickness of 0.5 μm by a spin coating process. The refractive index, light transmittance, and light resistance thereof were measured and evaluated with the following testing methods.

(1) Measurement of Refractive Index

Each thin film of examples and comparative examples was measured for the refractive index at a test wavelength of 589 nm at a temperature of 25° C. by means of a multi-wavelength Abbe refractometer (DR-M2 manufactured by ATAGO).

The closer the refractive index is to 1.7, which is the refractive index of the sapphire substrate 410 of the light emitting device 102, the more the light produced from the light emitting device 102 is adsorbed in the device protective layer 106, resulting in a higher luminous efficiency.

The samples of Comparative Examples 2 and 3 each use a silicone resin used as the device protective layer 106 excellent in light resistance. When the refractive index is smaller than 1.4, which is the refractive index of the resin, the light extraction efficiency drops. Accordingly, these samples were judged as bad.

(2) Light Transmittance

By means of an ultraviolet/visible light spectrophotometer (UV-365 manufactured by SHIMADZU CORPORATION), first, the base line was measured with only quartz glass. Then, each thin film manufactured in Examples or Comparative Examples was inserted on the sample side, and the wavelength was fixed at 400 nm. Thus, the light transmittance was measured.

The light emitting apparatus undergoing less light absorption in the device protective layer 106, and higher in light transmittance is brighter.

(3) Light Resistance

Each thin film manufactured in Examples or Comparative Examples was irradiated with ultraviolet light having an illuminance of 5,000 mW/cm² (@ 365 nm) in a 25° C. thermostat, and the thin film was subjected to light deterioration. Comparison with the light transmittance (@ 400 nm) in the initial stage of light deterioration was made with a spectrophotometer. The time elapsed until the light transmittance fell short of 90% was judged as the life.

In the case of a resin, it easily undergoes light degradation with ultraviolet light, and is colored. Accordingly, the light transmittance is reduced, and the life of the light resistance is shortened. For common intended use, when a life of 10,000 hours or more can be ensured, the apparatus is commercially viable.

### Example 1

To a mixed solution of 1.0 g of tetraethoxysilane, 7.0 g of isopropyl alcohol, and 0.25 g of alumina particles with a primary particle diameter of 50 nm, 0.18 g of 0.1N-HCl was added and stirred. The stirred mixed dispersion solution was formed in a film on a quartz substrate. The film-formed substrate was cured and sintered in a 150° C. oven, to manufacture a sample for evaluation. The evaluation results are shown in Table 1.

### Example 2

To 1.0 g of perhydropolysilazane, 0.25 g of alumina particles with a primary particle diameter of 50 nm were added, mixed and dispersed, and the mixture was formed in a film on a quartz substrate. The film-formed substrate was cured and sintered in a 150° C. oven, and then, subjected to a 90° C. 80% RH 3-hour treatment to manufacture a sample for evaluation. The evaluation results are shown in Table 1.

### Example 3

To perhydropolysilazane, a dibutyl ether solution containing alumina particles with a primary particle diameter of 50 nm dispersed therein was added. The mixture was adjusted so that the ratio of alumina in the solid content was 80% by weight, and formed in a film on a quartz substrate. The heat treatment conditions for the film were set to be the same as those in Example 2. The evaluation results are shown in Table 1.

### Comparative Example 1

To 1.0 g of an epoxy resin type sealing material for LED (trade name NT-8405 manufactured by NITTO DENKO), 0.25 g of alumina particles with a primary particle diameter of 50 nm were added, and the mixture was diluted with acetone, and the mixture was formed in a film on a 1-mm thick quartz substrate. The film-formed substrate was heated and cured at 150° C. for 2 hours. The evaluation results are shown in Table 2.

### Comparative Example 2

1.0 g of a silicone type sealing material (trade name KE1051 manufactured by Shin-Etsu Chemical Co., Ltd.), 0.25 g of alumina particles with a primary particle diameter of 50 nm were added, and the mixture was diluted with xylene, and the mixture was formed in a film on a 1-mm thick quartz substrate. The film-formed substrate was cured at 25° C. for 24 hours. The evaluation results are shown in Table 2.

### Comparative Example 3

1.0 g of a silicone type sealing material (trade name KE1051 manufactured by Shin-Etsu Chemical Co., Ltd.) was diluted with xylene, and the mixture was formed in a film on a 1-mm thick quartz substrate. The film-formed substrate was cured at 25° C. for 24 hours. The evaluation results are shown in Table 2.

### Comparative Example 4

To a solution of 1.0 g of tetraethoxysilane and 7.0 g of isopropyl alcohol, 0.18 g of 0.1N-HCl was added and stirred. The stirred mixed dispersion solution was formed in a film on a quartz substrate by means of a spin coater. The film-formed substrate was cured and sintered in a 150° C. oven to manufacture a sample for evaluation. The evaluation results are shown in Table 1.

### Comparative Example 5

To perhydropolysilazane, a dibutyl ether solution containing alumina particles with a primary particle diameter of 500 nm dispersed therein was added. The mixture was adjusted so that the ratio of alumina in the solid content was 80% by weight, and formed in a film on a quartz substrate. The heat treatment conditions for the film were set to be the same as those in Example 2. The evaluation results are shown in Table 2.

### Comparative Example 6

A film was formed on a quartz substrate in the same manner as in Example 3 and Comparative Example 6, except that alumina particles were not added. The evaluation results are shown in Table 2.

TABLE 1
Table 1 Examples

| | Example 1 | Example 2 | Example 3 |
|---|---|---|---|
| Binder | Tetraethoxysilane | Perhydropolysilazane | Perhydropolysilazane |
| Alumina particle diameter nm | 50 | 50 | 50 |
| Amount of alumina added wt % | 20 | 20 | 80 |
| Curing (sintering) temperature | 150 | 150 | 150 |
| ° C. | | | |
| Refractive index - | 1.42 | 1.45 | 1.55 |
| Light transmittance (@400 nm) % | 98 | 100 | 98 |
| Light resistance hr | >10000 | >10000 | >10000 |

TABLE 2
Comparative Examples

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Binder | Epoxy | Silicone | Silicone | tetraethoxysilane | Perhydropolysilazane | Perhydropolysilazane |
| Alumina particle | 50 | 50 | None | None | 500 | None |
| diameter nm | | | | | | |
| Amount of alumina | 20 | 20 | None | None | 80 | None |
| added wt % | | | | | | |
| Curing (sintering) | 150 | 25 | 150 | 150 | 150 | 150 |
| temperature ° C. | | | | | | |
| Refractive index - | 1.55 | 1.45 | 1.40 | 1.35 | 1.55 | 1.38 |
| Light transmittance | 98 | 100 | 100 | 100 | 40 | 100 |
| (@400 nm) % | | | | | | |
| Light resistance | 800 | 3000 | 3000 | >10000 | >10000 | >10000 |
| hr | | | | | | |

As apparent from Tables 1 and 2, comparison between Examples 1 and 2 and Comparative Examples 1 to 3 easily indicates that the light resistance of the device protective layer using a ceramic derived from tetraethoxysilane which is a metal alkoxide or perhydropolysilazane for a binder is excellent.

In the case of Comparative Example 3 in which particles have not been added, the refractive index reaches 1.4, resulting in a reduction of the light extraction efficiency. When Comparative Example 3 attains the refractive index of 1.4 with the actual device protective layer 106 having a favorable light resistance, unfavorably, the light extraction efficiency is degraded.

As indicated, in the case of Comparative Example 5 in which the particle diameter of the particles to be added is larger than the wavelength of the light to be emitted from the light emitting device, light scatters, and the light transmittance is largely reduced.

As apparent from the foregoing description, in accordance with these embodiments, by suppressing the light degradation of the light emitting device protective layer, and extracting the light produced by the light emitting device 102, it is possible to provide a vehicle lamp 10 high in luminous efficiency.

The present invention having been described with reference to the foregoing embodiments should not be limited to the disclosed embodiments and modifications, but may be implemented in many ways without departing from the spirit of the invention.

What is claimed is:

1. A light emitting apparatus comprising:
a device protective layer including a transparent binder (A) and particles (B), and
a light emitting device coated with the device protective layer, wherein the transparent binder (A). contains one or more ceramics, and the particles (B) have a smaller particle diameter than the wavelength of light produced by the light emitting device.

2. The light emitting apparatus according to claim 1, wherein the transparent binder (A) is a ceramic derived from one or more metal alkoxides or polysilazane.

3. The light emitting apparatus according to claim 1 , wherein the refractive index of the device protective layer is 1.4 or more.

4. The light emitting apparatus according to claim 1, wherein the particle diameter of the particles (B) is 100 nm or less.

5. The light emitting apparatus according to claim 1, wherein the device protective layer includes a phosphor therein.

6. The light emitting apparatus according to claim 1, wherein the light emitting device emits 420 or less nm near-ultraviolet light or short wavelength visible light.

7. The light emitting apparatus according to claim 1, wherein the light emitting device is mounted on a substrate by a flip-flop process.

8. A vehicle lamp comprising the light emitting apparatus according to claim 1.

9. The light emitting apparatus according to claim 2, wherein the refractive index of the device protective layer is 1.4 or more.

10. The light emitting apparatus according to claim 2, wherein the particle diameter of the particles (B) is 100 nm or less.

11. The light emitting apparatus according to claim 3, wherein the particle diameter of the particles (B) is 100 nm or less.

12. The light emitting apparatus according to claim 2, wherein the device protective layer includes a phosphor therein.

13. The light emitting apparatus according to claim 3, wherein the device protective layer includes a phosphor therein.

14. The light emitting apparatus according to claim 4, wherein the device protective layer includes a phosphor therein.

15. The light emitting apparatus according to claim 2, wherein the light emitting device emits 420 or less nm near-ultraviolet light or short wavelength visible light.

16. The light emitting apparatus according to claim 3, wherein the light emitting device emits 420 or less nm near-ultraviolet light or short wavelength visible light.

17. The light emitting apparatus according to claim 4, wherein the light emitting device emits 420 or less nm near-ultraviolet light or short wavelength visible light.

18. The light emitting apparatus according to claim 5, wherein the light emitting device emits 420 or less nm near-ultraviolet light or short wavelength visible light.
